(19) United States
(12) Patent Application Publication
(10) Pub. No.: US 2014/0210226 A1
(43) Pub. Date: Jul. 31, 2014

(54) PROTECTOR GUARD FOR TRUCK OR TRAILER

(71) Applicant: Kenny Cobb, Pittsburgh, PA (US)

(72) Inventor: Kenny Cobb, Pittsburgh, PA (US)

(21) Appl. No.: 13/752,083

(22) Filed: Jan. 28, 2013

(51) Int. Cl. B62D 25/02

(52) U.S. Cl. CPC B62D 25/02
USPC 296/39.1; 296/39.2

(57) ABSTRACT

A laminated composite guard to protect the rub rail of a flatbed or, alternatively, the side wall of a box van, is disclosed. The guard is formed of at least three layers: a fibrous fabric such as carbon fiber sandwiched between two planar members of high impact resistant plastics, such as polycarbonate or polymethylmethacrylate. A fourth layer of an elastomeric polymer may coat the outer surface that abuts the rub rail. Hangers such as a bungee strap or hook bracket holds the guard against the planar portion of the truck to be protected from damage caused by forklifts or other loading equipment.

### BACKGROUND OF THE INVENTION

The present invention relates generally to the field of transportation, and to a guard or protector panel for trucks and trailers that transport goods on the highways. More particularly, the invention relates to a composite guard or protector panel for protecting and minimizing damage to rub rails and/or to side panels during loading of such trucks.

“Flatbed” trucks and trailers and “box” vans and trailers are well known and used to transport cargo on the highways and roads of the United States and other countries. Flatbed trucks may be of the fixed variety or an articulated, tractor-trailer variety. Flatbed trucks include a deck or surface onto which cargo is loaded. Box vans or box trailers include side walls and a roof to form an enclosed “box-like” interior into which cargo is loaded. The nature of the cargo is immaterial to the present application; however truck owners and drivers often attempt to maximize profits by carrying as heavy a cargo load as is legally permissible.

A metal frame often surrounds the perimeter of the deck or bed of a flatbed, and the frame may include stake pockets and a rub rail. The rub rail often serves multiple functions: (1) to aid in securing the load to the deck via securement means such as tie-down chains, straps and the like; (2) to visibly mark the boundaries of the bed, using lights and/or reflective DOT tape; and (3) to protect the side edges of the deck from damage during loading. The frame and rub rail are typically steel or aluminum, but may also be a composite material or alloy.

However, the rub rail, while protecting the deck or bed of the truck, itself often becomes damaged by forklifts or other cargo-loading equipment. For example, damage may occur when a forklift operator does not raise his load sufficiently high to clear the bed height and instead strikes the fork, pallet or cargo into the rub rail, bending or breaking it. Repair of this damage can be expensive. It has been estimated that even a minor repair of the rub rail involves welding and replacing damaged parts and may cost a minimum of about $1,200 dollars for each instance. Similar damage can occur to the side wall panels of box vans and trailers when a fork lift operator is loading or unloading in the interior of the box.

Rub rail and deck/bed protection devices have been described in the patent literature. For example, U.S. Pat. No. 5,154,463 to Hershey describes two embodiments. In a first embodiment, and protecting device is formed of angle iron and includes protrusions sized and spaced to fit into the stake pockets of a flatbed truck. Thus, a horizontal leg of the angle protects a top edge surface and a vertical leg protects the side face of a rub rail. In a second embodiment, an elastomeric material having an arcuate surface replaces the angle iron. In theory, the arcuate surface may deflect a fork upward and over the guard onto the bed surface.

While these embodiments may afford some rub rail protection, they still suffer some drawbacks. For example, angle iron can be quite heavy. Carrying enough angle iron to protect the truck bed adequately involves a significant weight consideration. In order for a driver to carry this additional weight in protecting angle irons, he must reduce his cargo load and therefore his profits. Additionally, the elastomeric guards are soft and do not afford the impact resistance desired. It is still quite possible to cause damage to rub rails through the elastomeric guard.

The present invention seeks to overcome these drawbacks by providing a lightweight and portable, yet impact resistant and durable laminated guard for protecting the rub rails of trucks and trailers. The guard protects not only the rub rail, but also the stake pockets and any reflective DOT tape that is installed along the rail.

The present invention also seeks to overcome these drawbacks by providing a lightweight and portable, yet impact resistant and durable laminated guard panel for protecting the interior side walls of trucks and trailers.

### SUMMARY OF THE INVENTION

In one aspect, the invention comprises a composite protective guard for a planar truck part, such as a rub rail, interior side wall face or other planar part. The guard comprises:

a first planar member of an impact resistant plastic and a second planar member of an impact resistant plastic, the two planar members having similar length and width dimensions;

a fibrous fabric layer disposed between the first and second planar members and adhered to both planar members to form a laminated composite guard having opposed outer surfaces; and

at least one hanger for securing the guard to the truck such that the outer surface of the second planar member is oriented adjacent and approximately parallel to the planar truck part to be protected.

In most embodiments, the composite guard further comprises an elastomeric polymer layer disposed on the outer surface of the second planar member, as an interface between the guard and the planar truck part. In some embodiments, the first and second planar members are between about ⅛ inch and about ½ inch thick. Typically the second planar member serves as the base and is thicker than the first planar member, for example, the first planar member may be about ⅛ inch thick and the second planar member may be about ¼ inch thick. The first planar member is optionally transparent or translucent, such as polycarbonate, polymethylmethacrylate (PMMA) or acrylic, so that the fibrous fabric layer can be seen beneath. Optionally the fabric layer is brightly colored and/or reflective.

In some embodiments, the fibrous fabric layer is a carbon fiber fabric, or Kevlar-carbon fiber or similar fabric. The fabric may have a fabric weight between about 4 and about 8 oz.

In some embodiments, the guard of has a width dimension from about 1.5 to about 6 inches (so as to cover a rub rail) and the guard includes a hanger adapted to hold the guard against a planar rub rail of a flatbed. In other embodiments, the guard of has a width dimension from about 14 to about 24 inches (so as to cover a side wall panel) and the guard includes a hanger adapted to hold the guard against a side wall under a load rail.

In some embodiments, the hanger comprises a strap attached to a top edge of the guard and adapted to wrap around the rub rail and re-attach to a bottom edge of the guard. In other embodiments, the hanger comprises a at least one hook bracket attached to the guard and adapted to fit over the rub rail to secure the guard to the rub rail.

Other advantages and features are evident from the following detailed description.

### BRIEF DESCRIPTION OF THE DRAWINGS

The accompanying drawings, incorporated herein and forming a part of the specification, illustrate the present invention in its several aspects and, together with the description, serve to explain the principles of the invention. In the drawings, the thickness of the lines, layers, and regions may be exaggerated for clarity.

FIG. 1 is a top perspective view of a truck bed including a rub rail and showing loading damage associated with the rub rail;

FIG. 2 is a side end view, partially cut away, of one embodiment of a truck rub rail having the guard of the invention installed along a section of the rail;

FIG. 3 is a cross-sectional view of one embodiment of the guard;

FIG. 4 shows an alternative fastening means for securing the guard to a truck rub rail;

FIG. 5 shows yet another alternative fastening means for securing the guard to a truck rub rail;

FIG. 6 is a perspective drawing of a different embodiment of the guard, one designed to protect the interior side wall panel of a box van; and

FIG. 7 is an enlarged view of one embodiment of a hanger for securing the guard of FIG. 6 in place.

Various aspects of this invention will become apparent to those skilled in the art from the following detailed description of the preferred embodiment, when read in light of the accompanying drawings.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

Unless otherwise indicated, all numbers expressing ranges of magnitudes, such as quantities of ingredients, properties such as molecular weight, reaction conditions, dimensions and so forth as used in the specification and claims are to be understood as being modified in all instances by the term “about.” All numerical ranges are understood to include all possible incremental sub-ranges within the outer boundaries of the range. Thus, a range of 1/16 to ⅜ inches discloses, for example, ⅛ to ¼, 1/16 to 9/32, 3/32 to 5/16, and 3/16 to ⅜ inches, etc. DOT stand for the Department of Transportation, the federal agency that regulates travel on the nation's highways. As used herein, the term “flatbed” may be used to describe any transportation vehicle with a flat deck and no permanent side walls or roof, without regard to whether the nature of the vehicle is articulated or fixed. As used herein, the term “box” (as in box van or box trailer) may be used to describe any transportation vehicle with permanent side walls and a roof or cover defining an enclosed interior, without regard to whether the nature of the vehicle is articulated or fixed. “Articulated” in this context refers to a separately powered “tractor” that pivotably couples to a trailer, allowing the trailer and tractor to pivot at the point of articulation.

FIG. 1 illustrates a portion of a flat bed truck or trailer 10 having a frame 12 surrounding a flat bed or deck 14. The rectangular frame 12 is generally made of a metal, such as aluminum or steel and may be rectangular in cross section as well. The deck 14 may be made of wood or metal and typically extends to the inside edge of the frame 12. Welded to the outside of the frame 12 are stake pockets 16 and stanchions 18 that extend laterally outwardly from the deck 14 to support a rub rail 20. For some cargo loads, the driver may wish to insert vertical upright supports (aka “stakes,” not shown) or sections of vertical fence (not shown) into the stake pockets 16 to aid in retaining the cargo load on the flat bed deck 14. As seen in the area designated 22, the rub rail 20 can incur bending or breaking damage due to the impact from equipment such as fork lift or other loaders used to load cargo onto the flatbed deck 14. As previously mentioned, repairs to these rub rails can be expensive, especially if frequently undertaken.

As noted above, the rub rail often serves multiple functions: (1) to aid in securing the load to the deck via securement means such as tie-down chains, straps and the like; (2) to visibly mark the boundaries of the bed, using lights and/or reflective DOT tape; and (3) to protect the side edges of the deck from damage during loading.

FIGS. 2 and 3 illustrate one embodiment of the guard 30 of the present invention. The overall dimensions of the guard 30 are designated as L, W and T for length, width and thickness, respectively. (L is shown in FIG. 6 only.) The L and W dimensions of the guard 30 are adapted to cover a length of rub rail 20 on a flatbed truck or trailer. The guard width W is typically from about 1.5 inches to about 6 inches and the guard length L may vary anywhere from about 2 feet to about 48 feet. Of course, for handling purposes, it is more desirable to manufacture shorter lengths and use multiple guards 30 to protect the whole length of a flatbed. For example, multiple shorter lengths L of 6 feet or 8 feet may be combined in end-to-end fashion to protect a typical 48 ft flatbed. As a practical matter, it is preferable to manufacture the guard 30 in lengths of about 4 to 8 feet.

According to one embodiment, the guard 30 is a laminated composite structure comprising at least 3 planar layers to form the full thickness T. A first planar member 32 is the outward most layer. First planar member 32 comprises a highly impact-resistant, plastic material, and typically is from about 1/16 to about ¼ inch thick. Suitable lightweight impact-resistant plastic materials include polycarbonates such as Lexan® or Makralon® and polymethylmethacrylates (PMMA) such as Lucite™ or Plexiglass™ Alternative polymeric resins suitable for high impact plastics are acrylics and modified acrylics, such as the products sold under the tradenames Acrylite® and Duraplex®, and certain phenolic resins. Polyamides such as Nylon™ may be used as well. Other impact-resistant plastics will be known to those skilled in the polymer arts. Properties desired for this material are light weight and resistance to the force of striking and resistance to shattering upon impact.

A second planar member 34 is also made of an impact-resistant plastic resin material, such as those described above in a connection with the first planar member 32. The material may be the same or different from the plastic material of the first planar member 32. The second planar member 34 may be as thick as or thicker than the first planar member. For example, the second planar 34 member may be from about ⅛ to about ½ inch thick, or from about 3/16 to about 5/16 inch thick. More typically the second planar member 34 is thicker than the first planar member 32.

The third layer is a fibrous fabric layer 36. The fabric layer 36 is laminated between the two planar members 32, 34, which gives the guard 30 additional strength. Additional strength comes both from the laminated structure of the composite and from the tensile strength of the fibrous fabric sandwiched into the laminate. The fibrous fabric layer may comprise a woven or non-woven fiberglass, but carbon fiber is an alternative fibrous fabric. Other alternative fiber fabrics include graphites, polyesters, nylons, polyethylenes such as Dyneema™, polyethylene terephthalates, polyproplyenes such as Innegra™, aramids and polyaramids such as Kevlar®, Twaron™ and Goldflex™, and hybrids or combinations of any of these fibers woven into a fabric.

Planar members 32, 34 have opposing major surfaces. When laminated, each planar member has an inner or interior surface, which is in contact with the fibrous fabric, and an outer or exterior surface that is facing outwardly from the fibrous fabric. Desirably, the first planar member 32 is transparent or at least translucent, so that one can see through the outward surface of the first planar member 32. The second planar member need not be transparent, and its outward surface 40 is directed towards the rub rail 20 of the flatbed. In some embodiments the fabric may be brightly colored, such as red, yellow, orange, or even fluorescent colors. In other embodiments, the fabric may be reflective. These colored and/or reflective fiber fabrics can easily be seen through a transparent or translucent first member 32 and can provide additional safety.

In embodiments using carbon fiber fabric, the fabric may be of weights ranging from about 2 oz to 10 oz, or from about 4 to about 8 oz weight. Fabric weight can be measured as the weight in ounces per yard of the fabric. One suitable carbon fiber fabric product is sold as “3K” in 2 by 2 twill and 5.8 oz weight, available from the Fibre Glast Development Company, Brookville, Ohio.

A good bonding adhesive is used to secure the two planar members and the fibrous fabric together in one composite structure. In general, adhesives may include hot melt adhesives, water-based adhesives, dry blended adhesives, solvent-based adhesives, solventless adhesives, epoxy adhesives, and film-forming adhesives. Some adhesives are polymers or co-polymers. Most adhesives can be applied by spraying, extrusion, rolling or slot coating the adhesive onto the planar member or fabric. The selected adhesive should exhibit strong bonding in both warm and cold climates and should be water-resistant and should not deteriorate in the presence of salt or particulate matter used on highways in icy conditions. Epoxy resins, and in particular marine epoxy resins exhibit these desired properties.

Epoxy resins generally come in two parts: A. the resin, and B. the curing agent. When combined, the two parts undergo a chemical reaction that gives off heat and crosslinks the resins together in a film coating. The cure time, film thickness and hardness, and other properties of the film coating depend on the exact nature of the chemistry involved. While many epoxy chemical types are known, the precise formula of each resin and curing agent and is often proprietary. For example, the Sherman Williams company describes the following chemical types: Amine epoxies, Polyamide epoxies, Amidoamine epoxies, Phenolics/Novolacs epoxies, Siloxane epoxies, Coal Tar epoxies, Water-based epoxies and Epoxy Esters. The Polyamide, Amidoamine and Water-based epoxies are said to possess good or excellent adhesive properties. (see, e.g. http://protective.sherwin-williams.com/tools/epoxy-coating-troubleshooting/epoxy-coating-comparison-chart/index.jsp) The epoxy manufacturer's instructions for preparation and curing time provide guidance. ProKote™ epoxy available from ProProducts, (http://www.proproducts.us/prokote.php) is one suitable epoxy adhesive.

Optionally, the guard 30 may use fasteners in addition to adhesives in to secure the layers together. For example, screws, bolts, rivets, clamps, etc. (not shown) may secure the laminated composite structure together. If used, ideally any screws or other fasteners do not protrude through the thickness T to puncture layer 38.

In some embodiments a fourth layer 38 may be added to the laminated composite guard 30. The fourth layer 38 is an elastomeric polymer that cushions the face 40 of the second planar member 34 against the rub rail 20. The layer may have a thickness from about 0 up to about ⅛ inch thick. Suitable elastomeric polymers provide three desirable functions. First, they protect face 40 of the planar member 34 to prevent scratching the surface of the guard 30. Second, they increase the friction between the mating surfaces of the rub rail 20 and the face 40 of the guard 30 and serve to help keep the guard 30 in place along the rub rail 20. Third, they offer at least some compressive elasticity when the guard 30 is pressed into the rub rail 20, such as when pressure is applied by a forklift or other loading equipment. Suitable elastomeric polymer materials include polyurethanes and epoxy polymers. The brand Rhino™ linings provides some exemplary and suitable elastomers for the fourth layer.

In operation, the guard 30 is simply attached to the flat bed such that the face 40 lies adjacent the rub rail 20. FIGS. 2, 4 and 5 illustrate. The guard is held in position by a securement device or hanger, collectively referred to as a “hanger”. The embodiments of FIGS. 2 and 4 both include as the hanger a bungee cord or strap 44 that secures the guard 30 in place. A typical bungee strap 44 includes two “S” shaped hooks 46, 46′, one at each end of the strap as shown in FIG. 4. The hooks 46, 46′ may be inserted into holes 48 bored into the guard 30. Alternatively, the strap 44 may stretch completely around the guard 30 and the hooks 46, 46′may simply connect to one another (not shown).

While a conventional bungee straps is depicted in FIG. 4, the invention also encompasses straps or tie downs that are more specifically adapted to the guard 30 and typical rub rails. For example, instead of hooks at both ends of the strap, one end of a strap may be directly fastened to the guard 30 as seen in FIG. 2. In this variation, the bungee cord 44 is passed through a hole 49 in the guard and is knotted, riveted, screwed, bolted, glued or otherwise fastened to the guard 30. FIG. 2 depicts a bungee strap 44 with a knot 51 at the upper end of the guard 30 and a single hook 46′ at the lower end secured in the hole 48. Of course, the bungee strap of either FIG. 2 or FIG. 4 may alternatively loop over the rub rail 20 and attaching back to the strap itself rather than to the guard 30. It is contemplated in use that the driver will install the guards 30 only when loading and unloading the flatbed, and will not leave the guards 30 permanently installed while driving. It is desirable therefore that any such securing or hanging device is quickly and easily fastened and unfastened, and that the guards not add excessive weight. Multiple such straps may be used along the length of guard 30; for example, 4 to 6 over a length of 8 feet.

Another alternative hanger device is depicted in the embodiment of guard 130 shown in FIG. 5. The composite layers 132, 134, 136 and 138 of the guard 130 are substantially the same as layers 32, 34, 36 and 38, respectively of guard 30. However, a U-shaped hanger bracket 150 is secured to the guard 130 and it serves to hook over the top edge of the rub rail 20 as shown to hold the guard in place. The bracket 150 includes a first leg 152 which may be fastened to the guard 130 by any fastener 151, such as, for example, glue, screw, bolt, or rivet. Alternatively it may be laminated between the first and second planar members 132, 434 during manufacture.

A base 154 extends away from the first leg 152 by a distance somewhat greater than the thickness of a rub rail 20, and connects to a second leg 156. Second leg 156 extends downward and angles somewhat back toward the body of the guard 130 until it terminates in a bend outwardly at 158. The outwardly bent terminus 158 allows the bracket to slip easily over the rub rail 20, while the inwardly angled second leg 156 acts as a spring to retain the guard 130 in close proximity to the rub rail 20. Multiple such hooks may be used along the length of guard 130; for example 4 to 6 over a length of 8 feet.

In yet other alternative mounting schemes, clamps, bolts with wing nuts, and other quick fastening clips may be used as hangers in place of or in addition to the bungee straps and brackets hanging devices described herein in order to quickly and easily secure the guards 30, 130 to the rail 20.

Referring to FIG. 6, yet another embodiment of a protective guard 230 is shown. FIG. 6 illustrates the interior of a box van or box trailer. The box includes a floor 214, one or more side walls 212, and typically a roof or ceiling (not shown) and one or more doors (not shown to close off the interior cargo area of the box. The inner face 213 of side wall 212 typically contains a load rail 215 which may contain slots or openings 217 into load-securing bars, straps, webs or panels may be connected. A load rail 215 extends approximately parallel to the floor 214 at a height of about 12-36 inches above the floor, typically from about 14 to 24 inches. The interior face 213 below the load rail 215 is often subjected to fork lift damage when loading and unloading the cargo area.

Guard 230 is shown in FIG. 6 protecting the area of side wall 212 below the load rail 215. For this embodiment, the guard 230 has width, length and thickness dimensions (W, L and T, respectively) that may differ from the guards 30, 130 of the other embodiments. The composition of the composite layering of the guard 230 is similar to guards 30, 130 having two planar members of impact-resistant plastics material sandwiching a fibrous fabric. These are all as described above and may produce a thickness T approximately comparable to the other guards, but desirably the thickness dimension T of this embodiment does not exceed the thickness of the load rail 215, so that the guard 230 protrudes into the cargo area of the interior no further than does the load rail 215. The length dimension L may also be similar to that of guards 30, 130 since the entire length of the interior side wall 213 may require protection. The width, W, however will be adapted to fit below the load rail 215 and extend substantially to the floor 214. Thus, the width dimension W may be from about 12 inches to about 36 inches, more typically from about 14 inches to about 24 inches, or from about 14 to about 18 inches. The dimensions of this guard 230, while different from guards 30, 130, is suitable for protecting the side walls 212 and particularly the interior face 213 of the side walls 212.

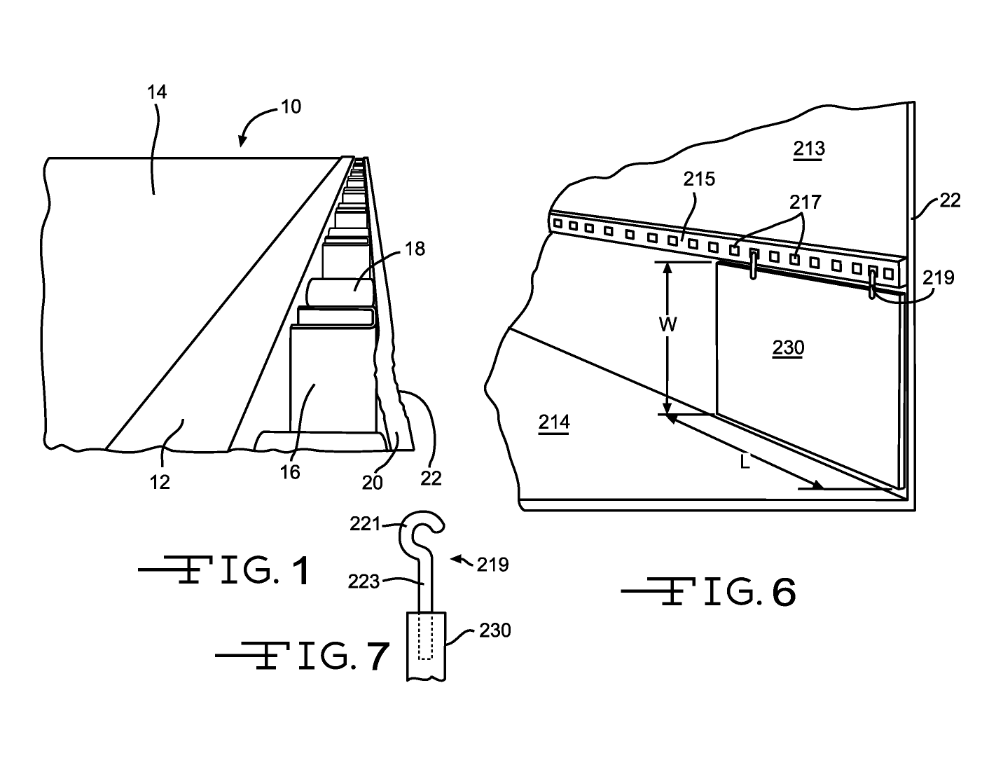

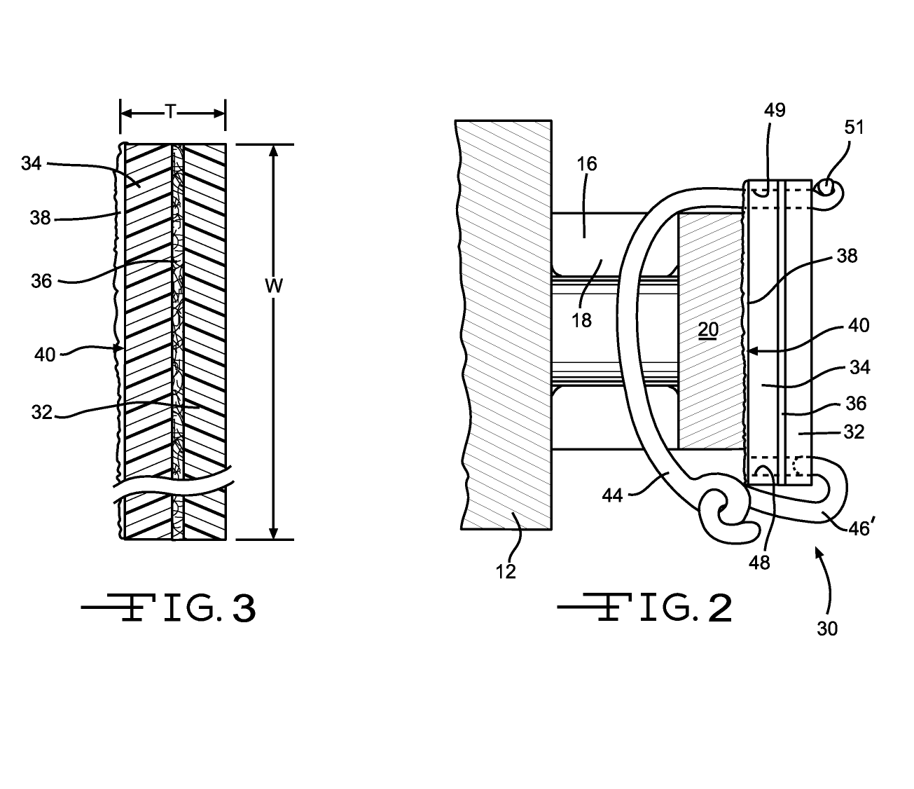

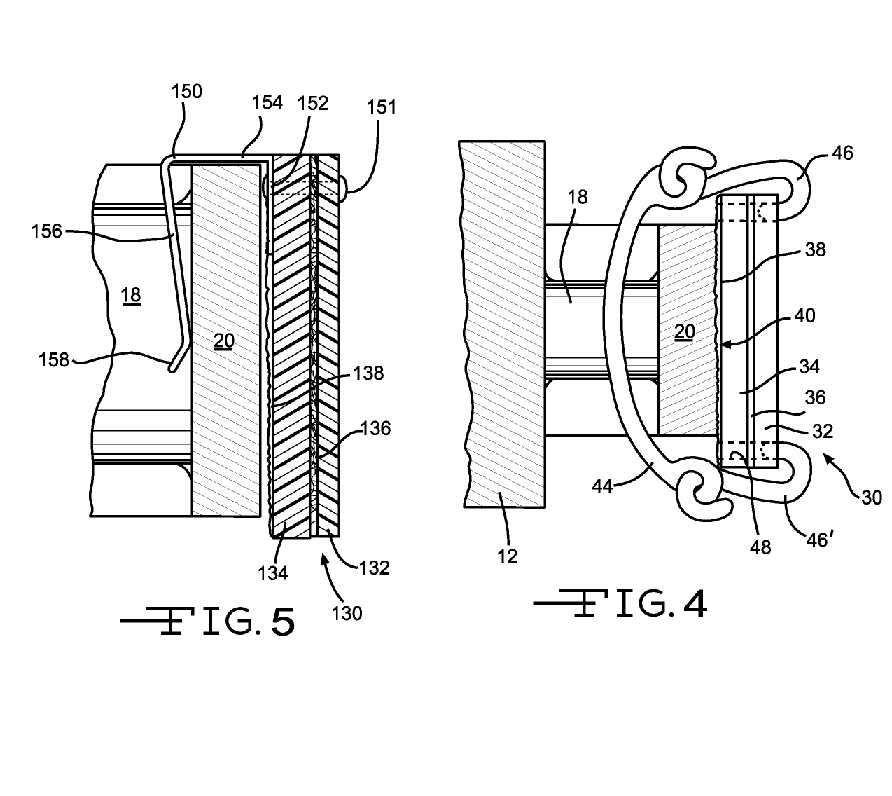

A hook or hanger 219 holds the guard 230 in position against the interior face 213 and under the load rail 215. As shown in FIG. 7, the hook 219 has a curved portion 221 that is adapted to insert into the holes 217 of the load rail. This curved portion 221 straightens out into a stem 223 that is attached or embedded into the edge of the guard 230. The hook 219 may optionally be threaded and screwed into the guard 230 or it may have barbs or other expansion devices to hold it in place. In addition or in the alternative, the hook 219 may be glued in place. Other variations include a flattened-style hook that may be screwed, bolted or glued to the front or back outer side of the guard 230 instead of being embedded into it. In use, the guard 230 may simply be hung on and suspended from the load rail 215 by means of placing the curved ends of the hooks 219 into the holes 217. Gravity will then retain the guard in position, leaving a small gap at the very bottom. Many other types of suspension hangers may be employed, in lieu of those described herein. Additionally, the guard 230 may rest directly on the floor 214 and be held in place against the face 213 of side wall 212 by an L-shaped pivot latch (not shown) that inserts into the load rail with the long side of the L in a horizontal orientation and twists roughly 90 degrees so that the long side of the L then extends downward to retain the guard 230 in place.

Manufacture of the guards of the present invention can proceed as follows. Large sheets (e.g. 4 by 8 feet) of suitable plastics materials are obtained. A thicker sheet of planar member is used as the base for construction. A layer of adhesive is applied to the sheet and the fiber fabric is laid over the adhesive. A second coating of adhesive may desirably be applied and a sheet of second planar member is pressed into the fabric and adhesive. The adhesive is allowed to cure under conditions suitable for the chosen adhesive. If desired, screws or other fasteners may be inserted into the composite to further secure the layers together. The laminate thus made is considerably stiffer than either planar member alone. The laminate is inverted and an elastomeric polymer is sprayed or coated on the face 40 that will contact the truck's rub rail or side wall. The sheet is then cut to suitable length and width dimensions, depending on the embodiment, and packaged.

The foregoing description of the various aspects and embodiments of the present invention has been presented for purposes of illustration and description. It is not intended to be exhaustive or all embodiments or to limit the invention to the specific aspects disclosed. Obvious modifications or variations are possible in light of the above teachings and such modifications and variations may well fall within the scope of the invention as determined by the appended claims when interpreted in accordance with the breadth to which they are fairly, legally and equitably entitled.

What is claimed is:

1. A composite protective guard for a planar truck part, the guard comprising:
a first planar member of an impact resistant plastic and a second planar member of an impact resistant plastic, the two planar members having similar length and width dimensions;
a fibrous fabric layer disposed between the first and second planar members and adhered to both planar members to form a laminated composite guard having opposed outer surfaces; and
at least one hanger for securing the guard to the truck such that the outer surface of the second planar member is oriented adjacent and approximately parallel to the planar truck part to be protected.

2. The composite guard of claim 1 further comprising an elastomeric polymer layer disposed on the outer surface of the second planar member, as an interface between the guard and the planar truck part.

3. The composite guard of claim 1 wherein at least one of the first and second planar members is between about ⅛ inch and about ½ inch thick.

4. The composite guard of claim 3 wherein the first planar member is about ⅛ inch thick and the second planar member is about ¼ inch thick.

5. The composite guard of claim 1 wherein the first planar member is transparent or translucent.

6. The composite guard of claim 1 wherein at least one of the first and second planar members is formed from a polycarbonate plastic.

7. The composite guard of claim 1 wherein the fibrous fabric layer is a carbon fiber fabric.

8. The composite guard of claim 7 wherein the first carbon fiber fabric has a fabric weight between about 4 and about 8 oz.

9. The composite guard of claim 1 wherein width dimension is from about 1.5 to about 6 inches and the guard includes a hanger adapted to hold the guard against a planar rub rail of a flatbed.

10. The composite guard of claim 9 wherein the carbon fiber fabric is brightly colored or reflective and visible through the first planar member.

11. The composite guard of claim 9 wherein the hanger comprises a strap attached to a top edge of the guard and adapted to wrap around the rub rail and re-attach to a bottom edge of the guard.

12. The composite guard of claim 9 wherein the hanger comprises at least one hook bracket attached to the guard and adapted to fit over the rub rail to secure the guard to the rub rail.

13. The composite guard of claim 9 wherein the length dimension is from about 4 feet to about 8 feet.

14. The composite guard of claim 1 wherein width dimension is from about 14 to about 24 inches and the guard includes a hanger adapted to hold the guard under a load rail and against a planar side wall of a box van or box trailer.

15. The composite guard of claim 14 wherein the hanger comprises at least two hooks, each having a curved portion adapted to fit into a hole in a load rail and a straight portion secured to the guard at or near a top edge of the guard, such that the guard can be suspended from the load rail.

16. The composite guard of claim 14 wherein the length dimension is from about 4 feet to about 8 feet.
